(19) United States
(12) Patent Application Publication
(10) Pub. No.: US 2025/0232456 A1
(43) Pub. Date: Jul. 17, 2025

(54) Knowledge Transfer Based on Multiple Views for Path Prediction

(71) Applicants: Hyundai Motor Company, Seoul (KR); Kia Corporation, Seoul (KR)

(72) Inventor: Hye Rin Lim, Seoul (KR)

(21) Appl. No.: 18/909,925

(22) Filed: Oct. 8, 2024

(30) Foreign Application Priority Data
Jan. 17, 2024 (KR) 10-2024-0007113

(51) Int. Cl. G06T 7/246; B60W 60/00; G01C 21/00; G06V 10/75; G06V 20/56; G06V 20/58; H04N 7/18

(52) U.S. Cl. CPC G06T 7/248; G01C 21/3822; G06V 10/751; G06V 20/58; G06V 20/588; H04N 7/183; B60W 60/0027; B60W 2556/40; G06T 2207/10016; G06T 2207/30256

(57) ABSTRACT

A knowledge transfer method allows for knowledge transfer based on images acquired from sensors with different views. The knowledge transfer method allows for knowledge learned from an infrastructure device including a top-view sensor to be transmitted to a vehicle including a perspective-view sensor, and the vehicle may predict a path for autonomous driving using the transferred knowledge. Rasterized semantic maps generated based on data acquired from each of the top-view sensor and the perspective-view sensor may be used to generate a motion flow result based on map-matching. The motion-flow result may be transferred to the vehicle for path prediction.

### CROSS REFERENCE TO RELATED APPLICATION

The present application claims priority to a Korean patent application 10-2024-0007113 filed Jan. 17, 2024, the entire contents of which are incorporated herein for all purposes by this reference.

### FIELD

The present disclosure relates a methods, devices and systems for using images acquired from sensors with different views. More particularly, the present disclosure relates an infrastructure device including a top-view sensor, a vehicle including a perspective-view sensor, methods for transferring data between the infrastructure device and the vehicle and methods for predicting a path for autonomous driving using data from the top-view sensor, data from the perspective-view sensor and communications between infrastructure device and the vehicle.

### BACKGROUND

Recently, moving objects tend to be equipped with autonomous driving functions for driving convenience. Autonomous driving functions are being developed to realizing full autonomous driving where a moving object has full control of driving without driver intervention in any situation. Recognition of a moving object or an object around the moving object and path prediction may be necessarily required for autonomous driving.

### SUMMARY

The following summary presents a simplified summary of certain features. The summary is not an extensive overview and is not intended to identify key or critical elements.

Systems, apparatuses, and methods are described for a knowledge transfer based on multiple views for path prediction. A method may comprise generating, based on first data acquired by a top-view sensor of an infrastructure device, a first rasterized semantic map; receiving, from a vehicle comprising a perspective-view sensor, a second rasterized semantic map generated based on second data acquired by the perspective-view sensor; determining, based on map matching between the first rasterized semantic map and the second rasterized semantic map, a motion flow result; and sending, to the vehicle, information indicating the motion flow result.

Also, or alternatively, a method may comprise: generating, by a processor and based on first data acquired from a perspective-view sensor of a vehicle, a second rasterized semantic map; sending, to an external infrastructure device comprising a top-view sensor, the second rasterized semantic map; receiving, from the external infrastructure device and based on the sending, a motion flow map based on map matching of the second rasterized semantic map and a first rasterized semantic map, wherein the first rasterized semantic map is based on data acquired from the top-view sensor; performing, based on the received motion flow map, path prediction for at least one of the vehicle or a neighbor object of the vehicle; and causing, based on the path prediction, control of autonomous driving of the vehicle.

Also, or alternatively, a vehicle may comprise: a perspective-view sensor; a memory storing a computer-readable instruction; and at least one processor. The instruction, when executed by the at least one processor, may cause the vehicle to: generate, based on data from the perspective-view sensor, a second rasterized semantic map; send, to an external infrastructure comprising a top-view sensor, the second rasterized semantic map; receive, from external infrastructure device, a motion flow map based on map matching the second rasterized semantic map and a first rasterized semantic map, wherein the first rasterized semantic map is based on data acquired from the top-view sensor; perform, based on the received motion flow map, path prediction for the vehicle or a neighbor object of the vehicle; and cause, based on the path prediction, control of autonomous driving of the vehicle.

These and other features and advantages are described in greater detail below.

### BRIEF DESCRIPTION OF THE DRAWINGS

FIG. 1 is a view exemplifying a concept of a vehicle that transmits and receives data in communication with an infrastructure device.

FIG. 2 is a view showing a configuration of a vehicle or an infrastructure device in accordance with an example of the present disclosure.

FIG. 3 illustrates a mutual configuration and a mutual operation of an infrastructure device 300 and a vehicle 100 in accordance with an example of the present disclosure.

FIG. 4 is a flowchart of a method for transferring knowledge of (e.g., information associated with and/or based on) data of a top-view sensor to a vehicle including a perspective-view sensor in accordance with an example of the present disclosure.

FIG. 5 is a flowchart of a method for transferring knowledge of (e.g., information associated with and/or based on) data of a top-view sensor from an infrastructure device including the top-view sensor to a vehicle including a perspective-view sensor and for using the knowledge to predict a path in the vehicle in accordance with an example of the present disclosure.

FIG. 6 is a flowchart of a method for predicting a path for autonomous driving by using data transferred from a top-view sensor, in a vehicle including a perspective-view sensor in accordance with an example of the present disclosure.

FIG. 7 is a flowchart of a method for transferring learned knowledge from an infrastructure device including a top-view sensor to a vehicle including a perspective-view sensor in accordance with an example of the present disclosure.

FIG. 8A and FIG. 8B illustrate an example of a first rasterized semantic map in accordance with an example of the present disclosure.

FIG. 9 illustrates an example of map matching between a first rasterized semantic map and a second rasterized semantic map in accordance with an example of the present disclosure.

FIG. 10 illustrates an example of a motion flow map in accordance with an example of the present disclosure.

FIG. 11 illustrates examples of motion prediction results for a vehicle and a neighbor object of the vehicle in accordance with an example of the present disclosure.

FIG. 12 illustrates an example of a detailed configuration of a vehicle in accordance with an example of the present disclosure.

### DETAILED DESCRIPTION OF THE INVENTION

Hereinafter, examples of the present disclosure will be described in detail with reference to the accompanying drawings, which will be easily implemented by those skilled in the art. However, the present disclosure may be embodied in many different forms and is not limited to the examples described herein.

In the following description, a detailed description of known functions and configurations incorporated herein will be omitted when such description may make the subject matter of the present disclosure rather unclear. Also, or alternatively, parts not related to the description of the present disclosure in the drawings are omitted, and like parts are denoted by similar reference numerals.

In the present disclosure, when a component is said to be “connected”, “coupled” or “linked” with another component, this may include not only a direct connection, but also an indirect connection in which a third component exists in between the component and the another component. Also, or alternatively, when a component “includes” or “has” other components, it means that other components may be further included rather than excluding other components unless the context clearly indicates otherwise.

In the present disclosure, terms such as first and second are used only for the purpose of distinguishing one component from other components, and do not limit the order, importance, or the like of components unless otherwise noted. Accordingly, within the scope of the present disclosure, a first component in an example may be referred to as a second component in another example, and similarly, a second component in an example may also be referred to as a first component in another example.

In the present disclosure, components that are distinguished from each other are intended to clearly describe each of their characteristics, and do not necessarily mean that the components are separated from each other. That is, a plurality of components may be integrated into one hardware or software unit, or one component may be distributed to be configured in a plurality of hardware or software units. Therefore, even when not stated otherwise, such integrated or distributed examples are also included in the scope of the present disclosure.

In the present disclosure, components described in various examples do not necessarily mean essential components, and some may be optional components. Accordingly, an example consisting of a subset of components described in an example is also included in the scope of the present disclosure. Also, or alternatively, examples including other components in addition to the components described in the various examples are included in the scope of the present disclosure.

In the present disclosure, phrases such as “A or B”, “at least one of A and B”, “at least one of A or B”, “A, B or C”, “at least one of A, B and C”, and “at least one of A, B, C or combination thereof” may each include any one of items listed therein or every possible combination of thereof.

The merits and characteristics of the present disclosure and a method of achieving the merits and characteristics will become more apparent from the examples described in detail in conjunction with the accompanying drawings. However, the present disclosure is not limited to the disclosed examples, but may be implemented in various different ways. The examples are provided to only complete the present disclosure and to allow those skilled in the art to fully understand the category of the disclosure.

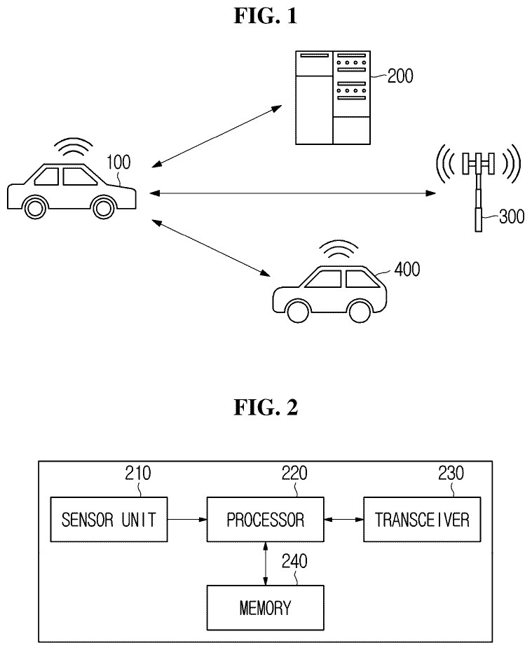

Hereinafter, referring to FIG. 1 to FIG. 2, a conceptual relationship between a vehicle and an infrastructure device will be described in accordance with an example of the present disclosure. First, FIG. 1 is a view exemplifying a concept of a vehicle that transmits and receives data in communication with another device.

The vehicle 100 may refer to a device capable of moving. The vehicle 100 is a ground vehicle that is driven on the ground and may be a normal passenger vehicle or commercial vehicle, a purpose built vehicle (PBV), and the like. Also, or alternatively, the vehicle 100 may be a four-wheel vehicle such as a sedan, a sports utility vehicle (SUV), and/or a pickup truck and may also be a vehicle with five or more wheels such as a bus, a lorry, a vehicle carrying a container, and/or a vehicle carrying heavy equipment.

The vehicle 100 may perform communication with an external server 200, an external infrastructure device 300 or another vehicle 400. For example, according to the present disclosure, the infrastructure device 300 may be an intelligent transportation system (ITS) device. However, this is merely an example, and the present disclosure is not limited thereto. Accordingly, a closed-circuit television (CCTV) including a top-view sensor may also or alternatively be an infrastructure device 300 according to the present disclosure.

For example, the server 200 may be an external device operated by a vehicle manufacturer or provided for an autonomous driving service. The server may be configured to communicate with the vehicle 100 (e.g., to receive connected data from the vehicle 100 and/or transmit (e.g., send) data necessary for autonomous driving). In order to support autonomous driving and/or various services for the vehicle 100, the server 200 may transmit various types of information and software modules used for controlling the vehicle 100 to the vehicle 100. The server 200 may transmit the information, for example, in response to a request and/or data transmitted from the vehicle 100 and/or a user device.

As an example of the infrastructure device, the infrastructure device 300 may be a road side unit (RSU). The infrastructure device 300 may assist a user in driving his own car or support autonomous driving of the vehicle 100 by exchanging vehicle recognition data, driving control and/or situation data, environment data surrounding a vehicle, and/or map data through vehicle-to-infrastructure (V2I) communications with the vehicle 100.

Also, or alternatively, through vehicle-to-vehicle (V2V) communications with the another vehicle 400, the vehicle 100 may support a driver's driving his own car or autonomous driving by exchanging the above-listed data. The vehicle 100 may communicate with another vehicle or another device based on cellular communication, wireless access in vehicular environment (WAVE) communication, dedicated short range communication (DSRC) or short range communication, and/or any other communication scheme.

FIG. 2 is a view showing a basic configuration of the vehicle 100 and/or the infrastructure device 300 in accordance with an example of the present disclosure. For example, a vehicle or infrastructure device configuration according to the present disclosure may be implemented with a sensor unit 210, a processor 220 for performing an operation according to an example of the present disclosure, a transceiver 230 for performing data transmission and reception to and from outside, and a memory 240 for storing an instruction for executing the processor 220 and system data. Particularly, in case the configuration of FIG. 2 corresponds to the vehicle 100, the sensor unit 210 may mean a perspective-view sensor, and in case the configuration of FIG. 2 corresponds to the infrastructure device 300, the sensor unit 210 may mean a top-view sensor. The sensor unit 210 may comprise a camera, for example.

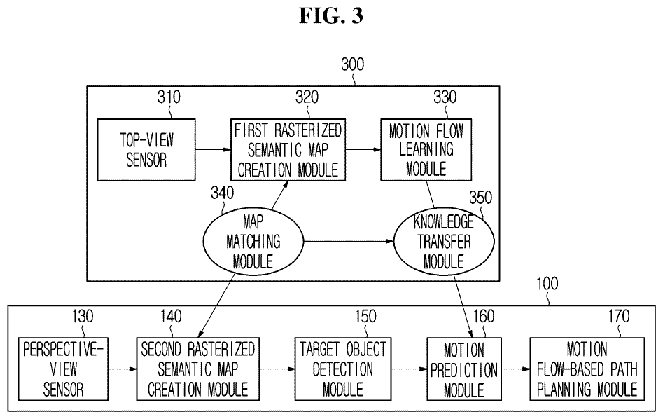

FIG. 3 illustrates a mutual configuration and a mutual operation of the infrastructure device 300 and the vehicle 100 in accordance with an example of the present disclosure.

For example, as described above, the infrastructure device 300 may be an ITS device, a RSU, and the like, but the present disclosure is not limited thereto. That is, the infrastructure device 300 according to the present disclosure may correspond to any device that includes a top-view sensor 310 and is capable of transferring data acquired through the top-view sensor 310 to the vehicle 100 including a perspective-view sensor 110. For example, a fixed CCTV including the top-view sensor 310 may correspond thereto.

The infrastructure device 300 according to the present disclosure may include the top-view sensor 310, a first rasterized semantic map creation module 320, a motion flow learning module 330, a map matching module 340, and a knowledge transfer module 350. However, each of the modules in the infrastructure device 300 is illustrated only to describe the contents of the present disclosure, but it does not mean that the modules are necessarily configured as independent and physical modules. That is, for example, each of the modules in the infrastructure device 300 may be implemented by the processor 220 mentioned in FIG. 2. That is, as described above, the infrastructure device 300 may be implemented with the top-view sensor 210, the processor 220 for performing an operation of each of the modules 320 to 350 in the infrastructure device 300 of FIG. 3, the transceiver 230 for performing data transmission and reception with the vehicle 100, and the memory 240 for storing an instruction for implementing the processor and system data.

On the other hand, the vehicle 100 according to the present disclosure may include the perspective-view sensor 130, the second rasterized semantic map creation module 140, the target object detection module 150, the motion prediction module 160, and the motion flow-based path planning module 170. However, each of the modules in the vehicle 100 is illustrated only to describe the contents of the present disclosure, but it does not mean that the modules are necessarily configured as independent and physical modules. That is, for example, each of the modules in the vehicle 100 may be implemented by the processor 220 of FIG. 2. That is, as described above, the vehicle 100 may be implemented with the perspective-view sensor 210, the processor 220 for performing an operation of each of the modules 140 to 170 in the vehicle 100 of FIG. 3, the transceiver 230 for performing data transmission and reception with the infrastructure device 300, and the memory 240 for storing an instruction for implementing the processor and system data.

For example, the top-view sensor 310 in the infrastructure device 300 may be a fixed bird's eye view (BEV) sensor. That is, in the present disclosure, the top-view sensor 310 may be an image acquisition device that is installed and fixed at a predetermined height or above in order to acquire a BEV image or an aerial image for a specific area at a predetermined altitude or above. Through the top-view sensor 310, the infrastructure device 300 becomes capable of acquiring consecutive and constant images for a specific area (for example, an intersection).

A bird-eye view may be taken a view above a certain distance from a ground and/or an object and may capture an area larger than a threshold (e.g., a threshold area configured in memory of the aerial vehicle). A bird-eye view image may indicate (and/or may be associated with) a perspective angle from the aerial vehicle (e.g., row, yaw, pitch information of the aerial vehicle and/or one or more cameras of the aerial vehicle). A bird-eye view image may indicate (and/or may be associated with) time information and/or other indicators of a frame of the bird-eye view image. A bird-eye view image may indicate (and/or may be associated with) one or more landmark images included in the bird-eye view image.

The perspective-view sensor 110 in the vehicle 300 may be an onboard sensor that is installed in the vehicle. That is, in the present disclosure, the perspective-view sensor 110 may be an image acquisition device, inside a vehicle, which is capable of acquiring a surrounding image while the vehicle runs or stops. Through the perspective-view sensor 110, the vehicle 110 becomes capable of acquiring a temporary image for a surrounding area (for example, a road where the vehicle 100 is running). “Perspective-view” as used herein refers to a different view than the “top-view” and/or birds-eye view, and may typically refer to a view from a more ground-based perspective, although not necessarily.

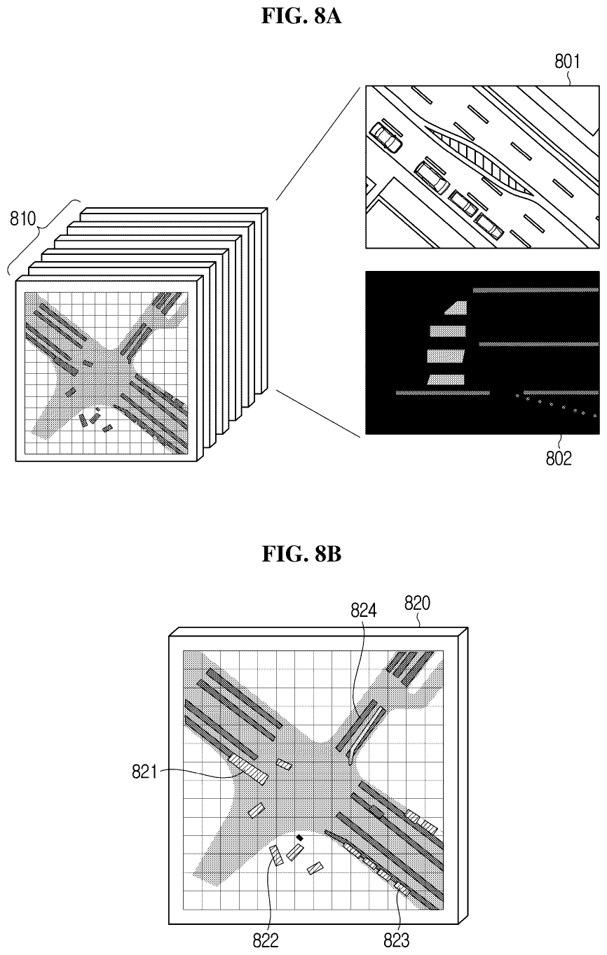

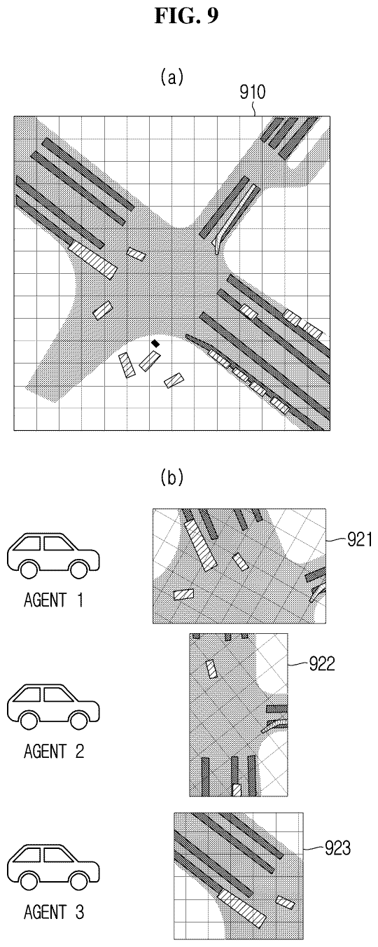

The first rasterized semantic map creation module 320 in the infrastructure device 300 creates a first rasterized semantic map from image data that is acquired by the top-view sensor. Also, or alternatively, the second rasterized semantic map creation module 140 in the vehicle 100 creates a second rasterized semantic map from image data that is acquired by the perspective-view sensor. For example, each of FIG. 8A and FIG. 8B illustrates an example of the first rasterized semantic map in accordance with an example of the present disclosure. Also, or alternatively, (a) and (b) of FIG. 9 illustrate examples of the first rasterized semantic map 910 and the second rasterized semantic maps 921, 922 and 923 in accordance with an example of the present disclosure. This will be described below.

Generally, mutual map matching is needed for knowledge transfer between sensors with different views. An example of the conventional knowledge transfer methods between different sensors is a knowledge distillation method. The knowledge distillation method is applied to knowledge transfer mainly from a high-performance higher model (for example, a teacher network) to a lower model with relatively low performance and possibly quicker response (for example, a student network). However, the conventional knowledge distillation method should be implemented only across a same domain. Accordingly, the conventional knowledge distillation method is rather difficult to apply to knowledge transfer between sensors with different views because the views have different domains from each other. Accordingly, in the present disclosure, the map matching process, which transforms the first/second rasterized semantic maps into maps with a same view (for example, BEV) and then makes resolutions identical with each other, is needed to make domains identical with each other between the top-view sensor 310 and the perspective-view sensor 110.

For example, for the map matching, the infrastructure device 300 may create semantic layers from an aerial image through the first rasterized semantic map. The semantic layers may represent probabilities for every pixel on a high-definition (HD) map. Also, or alternatively, the vehicle may create the second rasterized semantic map from the perspective-view sensor 110 and a number of layers may be determined according to an object and semantic information to be used.

The map matching module 340 in the infrastructure device 300 may match the first rasterized semantic map and the second rasterized semantic map. The second rasterized semantic map, created based on the perspective-view sensor 110 (for example, an onboard sensor of the vehicle 100), may correspond to a portion of the first rasterized semantic map created based on the top-view sensor 310. Specifically, the map matching may be performed by comparison of a feature identified in both the first rasterized semantic map and the second rasterized semantic map. For example, the feature may include terrain around a road or a shape thereof, such as a road edge, a road mark, and/or a lane. During the map matching, matching may be performed between grids that are marked on the first rasterized semantic map and the second rasterized semantic map respectively (for example, position and resolution matching). For example, (a) and (b) of FIG. 9 are example illustrations to describe map matching between the first rasterized semantic map 910 and the second rasterized semantic maps 921, 922 and 923 in accordance with an example of the present disclosure. This will be described below.

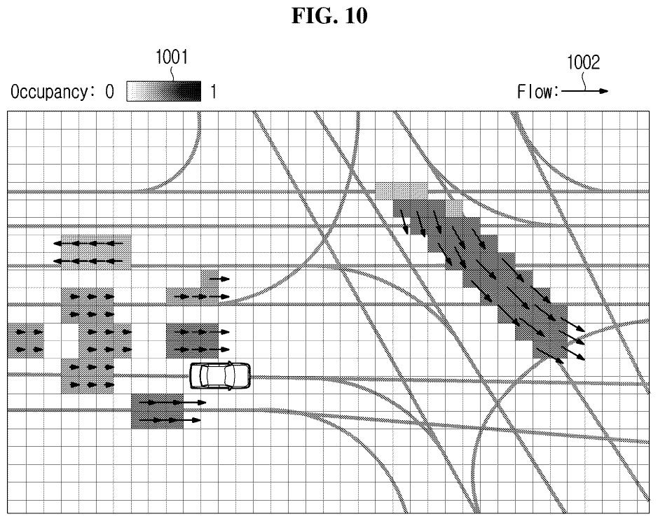

The motion flow learning module 330 in the infrastructure device 300 may create, as a motion flow result learned from the top-view sensor, a motion flow map that is transformed into a BEV occupancy grid vector form. The motion flow map may be a learning result that vectorizes a motion of each object or agent on the first rasterized semantic map in a pixel unit. That is, the motion flow map may represent a predicted result of a motion of each object/agent on an occupancy grid of the first rasterized semantic map. As a pixel position corresponds to a position on the map, a vector start point does not have to be separately stored. The motion flow map may be based on (e.g., created as) a multi-channel tensor with a same size as an image, and depth may correspond to the number of target agent types. For example, layers may be created for each agent type (for example, vehicle, pedestrian, cyclist, and the like)*[p (probability of object presence), v (velocity, vector size), h (heading, direction of vector) layer]. Also, or alternatively, the motion flow map may be created to have a same resolution as the first rasterized semantic map. The resolution may be a factor that determines a position error range. For example, FIG. 10 illustrates an example of the motion flow map in accordance with an example of the present disclosure. This will be described below.

The knowledge transfer module 350 in the infrastructure device 300 transfers knowledge for the motion flow map learned based on the top-view sensor 310 to the vehicle 100 including the perspective-view sensor 110 based on the map matching of the map matching module 340. Herein, the knowledge transfer module 350 becomes capable of transferring a motion flow result according to each object or agent on a semantic map with a same resolution based on map matching.

The target object detection module 150 in the vehicle 100 detects an object or agent around the vehicle through the second rasterized semantic map and performs localization that is necessary for autonomous driving.

Also, or alternatively, the motion prediction module 160 in the vehicle 100 receives a motion flow map, which represents a motion flow learning result according to each object or agent on a semantic map with a same resolution, from the knowledge transfer module 350 in the infrastructure device 300 and then performs motion prediction for the vehicle 100 itself or each object around the vehicle 100. Specifically, the motion prediction module 160 becomes capable of detecting an integrated motion flow for each target object by integrating a type of an object and a motion thereof detected by the target object detection module 150 and the motion flow map received through the infrastructure device 300.

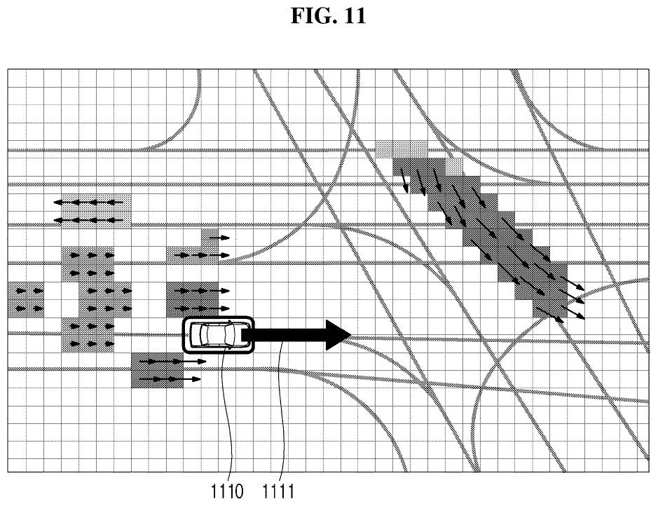

For example, when motion information indicating the position, current velocity and direction of a target object is created, the motion information has a same form as the motion flow map in consideration of (e.g., to allow for) integration with the motion flow map. Then, through integration with a motion flow vector learned through the motion flow learning module 330 in the infrastructure device 300, motion prediction for each target object becomes more accurate. That is, as the type and motion of a current object recognized by the perspective-view sensor 130 is integrated with the knowledge-transferred motion flow vector, more accurate and precise tracking becomes possible for a neighbor target object (for example, other vehicles, pedestrians, cyclists, etc) as well as the vehicle itself (for example, ego-vehicle). For example, FIG. 11 illustrates examples of motion prediction results for a vehicle and a neighbor object of the vehicle in accordance with an example of the present disclosure. This will be described below.

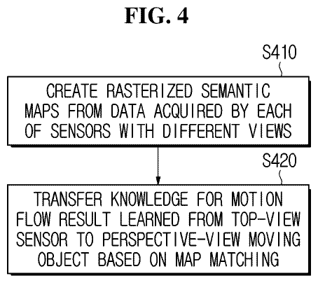

Hereinafter, referring to FIG. 4 to FIG. 6, a method according to an example of the present disclosure will be described in detail.

First, FIG. 4 illustrates a flowchart of a method for transferring information associated with data of a top-view sensor to a vehicle including a perspective-view sensor in accordance with an example of the present disclosure.

A method for transferring information associated with data of the top-view sensor to the vehicle 100 including the perspective-view sensor includes creating rasterized semantic maps from data acquired by each of the sensors with different views (S410). Also, or alternatively, the method includes transferring knowledge for a motion flow result learned from the top-view sensor to the perspective-view vehicle 100 based on the above-described map matching (S420).

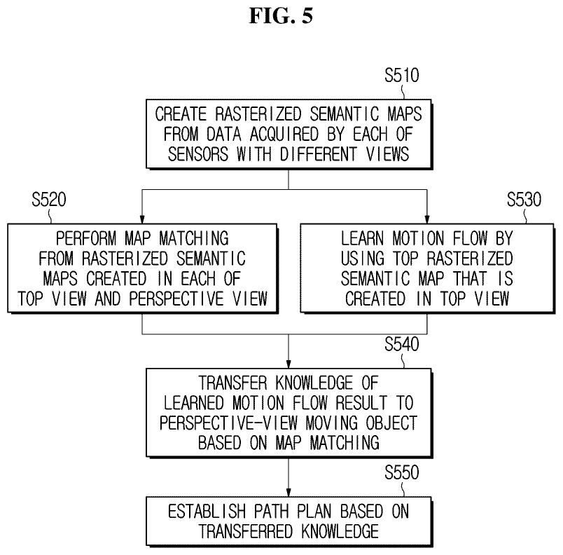

Also, or alternatively, FIG. 5 illustrates a flowchart of a method for transferring information associated with data of a top-view sensor from an infrastructure device including the top-view sensor to a vehicle including a perspective-view sensor and for using the knowledge to predict a path in the vehicle in accordance with an example of the present disclosure.

That is, in FIG. 5, the method according to an example of the present disclosure includes creating rasterized semantic maps from data acquired by each of the sensors with different views (S510). Also, or alternatively, the method includes, after step S510, performs map matching from rasterized semantic maps created in each of the top view and the bottom view (S520) and learning a motion flow by using a first rasterized semantic map that is created in the top view (S530). Herein, the learning of the motion flow at step S530 may use a map matching result of step S520. However, the present disclosure is not limited thereto.

Also, or alternatively, in FIG. 5, the method according to the example of the present disclosure further includes transferring information associated with the learned motion flow result to a perspective-view vehicle based on the map matching (S540) and establishing a path plan based on the transferred knowledge (S550).

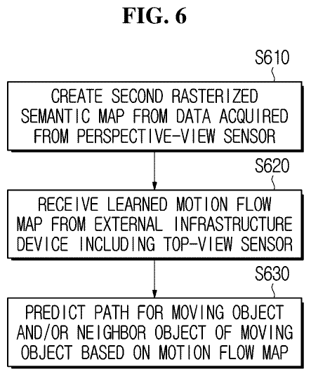

Also, or alternatively, FIG. 6 illustrates a flowchart of a method for predicting a path for autonomous driving by using data transferred from a top-view sensor, in a vehicle including a perspective-view sensor in accordance with an example of the present disclosure.

That is, in a vehicle including a perspective-view sensor according to an example of the present disclosure, a method for predicting a path for autonomous driving by using data transferred from a top-view sensor includes creating a second rasterized semantic map from data acquired from the perspective-view sensor (S610), receiving a learned motion flow map from an external infrastructure device including the top-view sensor (S620), and predicting a path for the vehicle and/or a neighbor object of the vehicle based on the motion flow map (S630). Herein, the neighbor object of the vehicle may include at least one of other vehicles, pedestrians and cyclists.

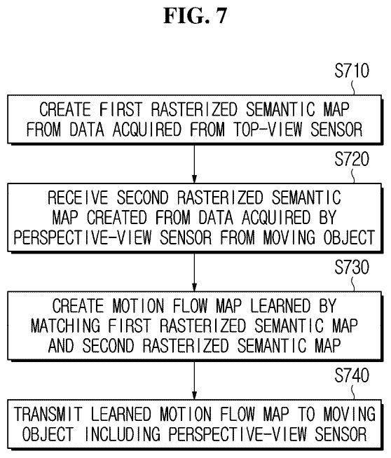

Also, or alternatively, FIG. 7 illustrates a flowchart of a method for transferring learned knowledge from an infrastructure device including a top-view sensor to a vehicle including a perspective-view sensor in accordance with an example of the present disclosure.

That is, according to an example of the present disclosure, a method for transferring learned knowledge from an infrastructure device including the top-view sensor to a vehicle including a perspective-view sensor includes creating a first rasterized semantic map from data acquired from the top-view sensor (S710), receiving a second rasterized semantic map created from data acquired by the perspective-view sensor from the vehicle including the perspective-view sensor (S720), creating a motion flow map learned by matching the first rasterized semantic map and the second rasterized semantic map (S730), and transmitting the learned motion flow map to the vehicle including the perspective-view sensor (S740).

FIG. 8A and FIG. 8B illustrate an example of a first rasterized semantic map in accordance with an example of the present disclosure. By using data acquired from the top-view sensor in the infrastructure device 300, semantic layers 810, which represent probabilities for every pixel on a high-definition (HD) map. may be created from an aerial image. The semantic layers may be created to be so diverse as to be distinguished according to each object. For example, referring to FIG. 8A, the layers may be distinguished into a layer 801 indicating a lane and a vehicle on a road, a layer 802 indicating a mark around a crosswalk on a road, and the like. Besides, various layers may be created such as a pedestrian walkway layer, a road edge layer, a bicycle lane layer, a lane marking layer, and a stop line layer.

FIG. 8B illustrates a form of a final first rasterized semantic map 820 integrating the created layers. That is, a first rasterized semantic map 820 of FIG. 8B is represented as an occupancy grid form, showing that the presence of an object on a grid may be indicated by a probability. For example, reference numerals 821, 822, 823 and 824 in FIG. 8B enable to know that there are objects on the grid of the first rasterized semantic map. Specifically, for example, the reference numeral 821 may denote a large vehicle or an object present on a lane of a road, the reference numeral 822 may denote a pedestrian or a stopped object present in a pedestrian precinct outside the lanes of the road, the reference numeral 823 may denote a vehicle or an object stopped or parked at a stop on the road, and the reference numeral 824 may denote a lane of the road.

FIG. 9 illustrates an example of map matching between the first/second rasterized semantic maps in accordance with an example of the present disclosure.

First, (a) of FIG. 9 illustrates an example of a first rasterized semantic map 910 described above. Also, or alternatively, (b) of FIG. 9 illustrates an example of a second rasterized semantic map. Herein, the first rasterized semantic map may include a plurality of second rasterized semantic maps 921, 922 and 923 that are created by respective vehicles or agents in a specific area. Specifically, the second rasterized semantic maps 921, 922 and 923 may be detailed maps for a predetermined area of the first rasterized semantic map 910.

The above-described map matching enables to match the first rasterized semantic map 910 with at least one of the second rasterized semantic maps 921, 922 and 923. Specifically, the map matching may be performed through comparison of a feature between the first rasterized semantic map 910 and at least one of the second rasterized semantic maps 921, 922 and 923. For example, the feature may mean terrain around a road or a shape thereof such as a road edge, a road mark, and a lane. Also, or alternatively, during the map matching, matching may be performed between grids that are marked on the first rasterized semantic map 910 and at least one of the second rasterized semantic maps 921, 922 and 923 respectively. A result of the map matching may be utilized for a knowledge transfer process for a motion flow learning result. Also, or alternatively, the result of the map matching may be used for learning for creating a motion flow map.

FIG. 10 illustrates an example of a motion flow map in accordance with an example of the present disclosure.

A motion flow map of the present disclosure is represented by a BEV occupancy grid vector form. Specifically, the motion flow map may include an occupancy probability indicator 1001, which may indicate a probability ranging from 0 to 1 indicating to an occupancy degree of a specific object in the motion flow map, and a flow indicator 1002 that indicates a motion flow of the object in the motion flow map. In this regard, the occupancy probability indicator 1001 may be marked to be distinguished according to occupancy intensity (e.g., a relative or absolute probability magnitude/amount/level/degree). Accordingly, the presence and/or size of a specific object in a BEV area (which may correspond to a whole map grid, for example) may be determined from the motion flow map (for example, this may be recognized from the presence/absence and/or size/color/intensity of a probability indicator occupying the map grid), and a motion flow of the object may be identified through the flow indicator 1002. That is, the motion flow map may correspond to a learning result that vectorizes a motion of each object or agent in (e.g., identified/recognized in) the first rasterized semantic map in a pixel unit. Herein, the specific object may include at least one of other vehicles, pedestrians and cyclists.

For example, the motion flow map may be a useful means of enabling knowledge transfer between domains with different views. For example, it may be a method of utilizing a flow map representing fluid flow like weather data and temperature for motion encoding of an agent.

FIG. 11 illustrates examples of motion prediction results for a vehicle and a neighbor object of the vehicle in accordance with an example of the present disclosure. For example, a moving direction or a driving path of a specific vehicle 1110 or an agent may be predicted (1111) from the grid occupancy probability indicator 1001 and the motion flow indicator 1002 of the above-described motion flow map. However, such a path prediction method may utilize any one of the conventional and widely known methods.

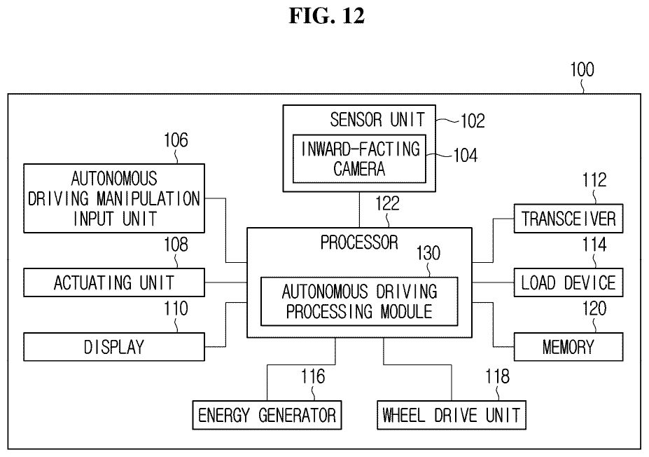

FIG. 12 illustrates an example of another detailed configuration of a vehicle in accordance with an example of the present disclosure.

Referring to FIG. 12, the vehicle 100 may be driven based on electric energy or fossil energy. In the case of electric energy, for example, the vehicle 100 may be a pure battery-based vehicle driven only by a high-voltage battery or employ a gas-based fuel cell as an energy source. Also, or alternatively, the fuel cell may use various types of gas capable of generating electric energy, and for example, the gas may be hydrogen. However, without being limited thereto, various gases may be applicable. In the case of fossil energy, the vehicle 100 is driven based on fuels such as gasoline, diesel, or liquefied gas, and may be equipped with an engine that drives a wheel drive unit 118 by combustion of the fuel. The engine may be included in an energy generator 116 from a perspective of providing a driving torque of a wheel to the wheel drive unit 118.

For convenience of explanation, the present disclosure describes the vehicle 100 as an example vehicle based on electric energy, but except regenerative braking, charge, and discharge described in the present disclosure, an example of the present disclosure may certainly be applicable to a vehicle based on fossil energy.

The vehicle 100 may be driven by being controlled in autonomous driving, and the autonomous driving may be implemented as semi-autonomous driving or full autonomous driving. Full autonomous driving may be provided as autonomous moving under the complete control of the processor 122 of the vehicle 100 without a user's intervention even in an uncertain driving situation. Semi-autonomous driving may be provided as autonomous moving that requires a driver's intervention in a specific driving situation. When the driving situation occurs, semi-autonomous driving may be implemented such that the processor 122 disables autonomous driving and switches control to the user, and thus the user performs manual driving. According to the autonomous driving levels defined by the Society of Automotive Engineers (SAE), semi-autonomous driving may correspond to the autonomous driving levels 1 to 4. The autonomous driving level 2 supports the autonomous driving controller 142 of the vehicle 100 to assist both steering and acceleration/deceleration, and as an example, the autonomous driving level 2 may be implemented to execute such functions as lane following assist (LFA), lane keeping assist (LKA), highway driving assist (HDA) and smart cruise control (SCC) and to disable the functions for switching to manual driving in a specific driving situation. The autonomous driving level 3 may support lane change and overtaking functions like the autonomous driving level 2 and switch control to a driver in case of a dangerous situation. The autonomous driving level 4 may be configured to control an entire vehicle by the autonomous driving controller 142 in response to each unexpected situation, while not requiring a driver's forward-looking responsibility, and to switch the control only in a remarkably uncertain situation like bad weather. In the present disclosure, the autonomous driving levels 2 and 3 are described as examples, but the examples of the present disclosure may also be applied to the autonomous driving levels 1 and 4.

Specifically, the vehicle 100 may include a sensor unit 102, an autonomous driving manipulation input unit 106, an actuating unit 108, and a display 110.

The sensor unit 102 may be equipped with various types of detectors for sensing various states and situations that occur in external and internal environments of the vehicle 100. According to an example of the present disclosure, the sensor unit 102 may be the perspective-view sensor 130 of FIG. 3. Specifically, the sensor unit 102 may be equipped with an outward-facing image sensor, a Lidar sensor, a radar sensor and the like to perceive dynamic and static objects present outside the vehicle 100. The sensor unit 102 may be equipped with a location sensor, a gyro sensor, an acceleration sensor, a wheel sensor, an autometer, a speed sensor and the like to identify its own location, driving position, and speed. Also, or alternatively, to monitor a user inside the vehicle 100, a condition of an occupant, and an operating situation of an internal device of the vehicle 100 that a user is capable of maneuvering, the sensor unit 102 may have an inward-facing camera 104, a biosensor for detecting biosignals of a driver and an occupant, and various detection modules for detecting the operation and state of an internal device. For example, the inward-facing camera 104 may be installed in a predetermined position inside the vehicle or be built into the display 110. The camera 104 may capture motions of various body parts of a driver and a passenger and deliver the captured motions to the processor 122, and the processor 122, for example, a user monitoring unit, may estimate a user's physical condition through a motion of a body part. A physical condition may be a degree of fatigue of a driver and/or a passenger. Also, or alternatively, a biosensor is provided as a contact-type sensor, which contacts a body part of a user to measure a biosignal, and may be configured in a pad form provided in a predetermined portion of, for example, a steering wheel and contacting a driver's hand or finger. For example, the biosensor may be configured to measure a user's pulse, blood pressure and ECG as biosignals or to acquire biosignals such as blood pressure and ECG indirectly based on biosignals that are directly measured. Based on biosignals acquired from the biosensor, a user tendency analysis and monitoring unit may estimate a physical condition such as the user's fatigue.

The present disclosure mainly describes sensors of the sensor unit 102 referred to for description of an example but may further include a sensor for detecting various situations not listed herein.

In order to enable a user such as a driver to activate or deactivate an autonomous driving function provided in the vehicle 100, the autonomous driving manipulation input unit 106 may be configured as an interface to use or release an autonomous driving mode requested from the user. For example, the autonomous driving manipulation input unit 106 may be implemented as a hard-type interface provided in a predetermined position in the vehicle 100 or a soft-type interface that is touchable on the display 100. In the case of a hard-type interface, for example, the autonomous driving manipulation input unit 106 may be installed on a steering wheel, a dashboard, and the like. The autonomous driving manipulation input unit 106 may be configured as an interface that enables a user to select various functions provided at a corresponding level of autonomous driving. As another example, the autonomous driving manipulation input unit 106 may receive a user's input requesting activation of an autonomous driving mode, and the processor 122 may execute a function suitable for a driving situation among functions of autonomous driving at a corresponding level, even if the user does not request any specific function. For example, as for the autonomous driving level 2, an option key may be provided as an interface for a plurality of functions such as LFA, LKA, HDA, and SCC.

The actuating unit 108 may be equipped with at least one module for implementing a driving operation and perform at least one driving operation of longitudinal control like acceleration/deceleration and transverse control like steering. The actuating unit 108 may be equipped with not only a pedal and a steering wheel accepting a user's request for the control but also various operating modules for generating a driving operation according to the request in the wheel drive unit 118.

The display 110 may serve as a user interface. By the processor 122, the display 110 may display an operating state and a control state of the vehicle 100, path/traffic information, information on an energy remaining quantity, a content requested by a driver, and the like to be output. The display 110 may be configured as a touch screen capable of sensing a driver input and receive a request of a driver indicated to the processor 122.

The vehicle 100 may include a transceiver 112, a load device 114, the energy generator 116, and/or the wheel drive unit 118.

The transceiver 112 may support mutual communication with the server 200, the infrastructure device 300, and the neighbor vehicle 400. In the present disclosure, the transceiver 112 may transmit data generated or stored during driving to the server 200 and receive data and a software module transmitted from the server 200. In the present disclosure, the vehicle 100 may transmit and receive data used in a method according to the present disclosure to and from the outside through the transceiver 112.

The load device 114 may be an auxiliary equipment mounted on the vehicle 100, which consumes power supplied from the energy generator 116 by use of an occupant or user or converted from output of the energy generator 116. The load device 114 may be a type of electric device for non-driving purpose excluding a driving power system like the wheel drive unit 118 in the present disclosure. For example, the load device 114 may be various devices installed in an air-conditioning system, a light system, a seat system and the vehicle 100.

The energy generator 116 may generate and supply power and electricity used for a driving power system like the wheel drive unit 118 and the load device 114. In case the vehicle 100 is driven based on electric energy, for example, the energy generator 116 may be configured as an electric battery or be configured as a combination of an electric battery and a fuel cell for charging the battery. In the case of a combination of an electric battery and a fuel cell, the energy generator 116 may include a tank for storing a material used to produce power of the fuel cell, for example, hydrogen gas. In case the vehicle 100 is driven based on fossil energy, the energy generator 116 may be configured as an internal combustion engine.

The wheel drive unit 118 may include a plurality of wheels, a driving force transfer module for generating and giving a driving force to wheels or for transferring a driving force, a braking module for decelerating the driving of wheels, and a steering module for realizing transverse control of wheels. In case the vehicle 100 is driven based on electric energy, the driving force transfer module may be configured as a motor module that generates a driving force based on power output from an electric battery. In case the vehicle 100 is operated based on fossil energy, a driving force transfer module may be equipped with transmission and a gear module that transfer power of an internal combustion engine.

Also, or alternatively, the vehicle 100 may include the memory 120 and the processor 122.

The memory 120 may store an application for controlling the vehicle 100 and various data and load the application or read and record data at a request of the processor 122. In the present disclosure, the memory 120 may store an application and at least one instruction for checking whether or not a release-predicted section of an autonomous driving mode is expected on a driving path of the vehicle 100 controlled in the autonomous driving mode, giving, if the section is expected, a prior notice about release of the autonomous driving mode, and controlling the vehicle 100 in a predetermined mode according to whether or not a release condition of the autonomous driving mode is satisfied.

To this end, for example, the memory 120 may store and/or manage driving history information of a user (or driver) of the vehicle 100, the user's evasion of the release of autonomous driving, a concentrated threshold value, and reference data and map information that are applied for expecting a release-predicted section based on driving environment information.

The map information stored in the memory 120 may be used to create a driving path set to the vehicle 100 at a request of a user or the processor 122. Also, or alternatively, the map information may be used for autonomous driving and include a low definition map or include an HD map together with the map. The map information may be provided to have various information and data included in the driving environment information.

The processor 122 may perform overall control of the vehicle 100. The processor 122 may be configured to execute an application and an instruction stored in the memory 120. In the present disclosure, the processor 122 may check whether or not a release-predicted section of an autonomous driving mode is expected on a driving path of a vehicle controlled in the autonomous driving mode by using an application, an instruction and data stored in the memory 120 and execute notification of a prior notice about the release of the autonomous driving mode in response to a checking result regarding whether or not the release-predicted section of an autonomous driving mode is expected. Also, or alternatively, when a release condition of the autonomous driving mode is satisfied, the processor 122 may perform processing of releasing the autonomous driving mode to make the vehicle controlled by a user's manual driving.

Recently, vehicles are increasingly equipped with autonomous driving functions for driving convenience. Autonomous driving functions are being developed to realize full autonomous driving where a vehicle has full control of driving without driver intervention in any situation. Recognition of a vehicle or an object around the vehicle and path prediction to avoid such objects may be necessarily required for autonomous driving.

The present disclosure provides methods, devices and systems for transfer of information from images acquired from sensors with different views. Also, or alternatively, the present disclosure provides methods, systems and devices for performing object recognition and path prediction suitable for autonomous driving through the transfer of information.

The technical problems solved by the present disclosure are not limited to the above technical problems and other technical problems which are not described herein will be clearly understood by a person having ordinary skill in the technical field, to which the present disclosure belongs, from the following description.

According to an example of the present disclosure, a method for transferring knowledge of (e.g., information associated with or about) data from a top-view sensor to a vehicle including a perspective-view sensor may include creating a rasterized semantic map from data acquired from each of the top-view sensor and the perspective-view sensor and transferring knowledge of a motion flow result learned from the top-view sensor to the vehicle including the perspective-view sensor based on map matching.

Also, or alternatively, according to an example of the present disclosure, the map matching may be performed through feature comparison between a first rasterized semantic map created from the top-view sensor and a second rasterized semantic map created from the perspective-view sensor.

Also, or alternatively, according to an example of the present disclosure, the motion flow result learned from the top-view sensor may be created as a motion flow map that is transformed into a bird eye view (BEV) occupancy grid vector form.

According to another example of the present disclosure, a method for predicting a path for autonomous driving, in a vehicle including a perspective-view sensor, by using data transferred from a top-view sensor may include creating a second rasterized semantic map from data acquired from the perspective-view sensor, receiving, from external infrastructure including the top-view sensor, a motion flow map learned by matching the second rasterized semantic map and a first rasterized semantic map created from data acquired from the top-view sensor, and performing path prediction for the vehicle and/or a neighbor object of the vehicle based on the received motion flow map.

Also, or alternatively, according to another example of the present disclosure, the received motion flow map may be created by being transformed into a bird eye view (BEV) occupancy grid vector form after map matching between the first rasterized semantic map and the second rasterized semantic map through feature comparison between the first rasterized semantic map and the second rasterized semantic map.

Also, or alternatively, according to another example of the present disclosure, the performing of the path prediction may include detecting a type and a motion of the neighbor object recognized from the perspective-view sensor in the vehicle, detecting an integrated motion flow for each object by integrating the detected type and motion of the object and the received motion flow map, and predicting a path of the neighbor object based on the integrated motion flow.

Also, or alternatively, according to another example of the present disclosure, the performing of the path prediction may include detecting a motion of the vehicle recognized from the perspective-view sensor in the vehicle, detecting an integrated motion flow by integrating the detected motion of the vehicle and the received motion flow map, and predicting a path of the vehicle based on the integrated motion flow.

According to another example of the present disclosure, a vehicle, which includes a perspective-view sensor, is capable of autonomous driving and performs path prediction for autonomous driving by using data transferred from the top-view sensor, may include a memory storing a computer-readable instruction and at least one processor that is operated by the instruction. Herein, the instruction may instruct the at least one processor to create a second rasterized semantic map from data acquired from the perspective-view sensor, to receive, from external infrastructure including the top-view sensor, a motion flow map learned by matching the second rasterized semantic map and a first rasterized semantic map created from data acquired from the top-view sensor, and to perform path prediction for the vehicle and/or a neighbor object of the vehicle based on the received motion flow map.

Also, or alternatively, according to another example of the present disclosure, the received motion flow map may be created by being transformed into a bird eye view (BEV) occupancy grid vector form after matching the first rasterized semantic map and the second rasterized semantic map through feature comparison between the first rasterized semantic map and the second rasterized semantic map.

Also, or alternatively, according to another example of the present disclosure, in order to perform the path prediction of the neighbor object may detect a type and a motion of the neighbor object recognized from the perspective-view sensor in the vehicle, detect an integrated motion flow for each object by integrating the detected type and motion of the object and the received motion flow map, and predict a path of the neighbor object based on the integrated motion flow.

Also, or alternatively, according to another example of the present disclosure, in order to perform the path prediction of the vehicle, the at least one processor may detect a motion of the vehicle recognized from the perspective-view sensor in the vehicle, detect an integrated motion flow by integrating the detected motion of the vehicle and the received motion flow map, and predict a path of the vehicle based on the integrated motion flow.

Also, or alternatively, according to another example of the present disclosure, the map matching may be performed through feature comparison between a first rasterized semantic map created from the top-view sensor and a second rasterized semantic map created from the perspective-view sensor.

Also, or alternatively, according to another example of the present disclosure, the map matching may compare at least one of a road edge, a road mark, and a lane, which are included in the first rasterized semantic map and the second rasterized semantic map.

Also, or alternatively, according to another example of the present disclosure, the motion flow map may be created by being transformed into a bird eye view (BEV) occupancy grid vector form.

Also, or alternatively, according to another example of the present disclosure, the motion flow map may include an occupancy probability indicator, which indicates a probability according to an occupancy degree of a specific object in the motion flow map, and a flow indicator indicating a motion flow of an object in the motion flow map.

According to another example of the present disclosure, a method for transferring learned knowledge from an infrastructure device including a top-view sensor to a vehicle including a perspective-view sensor may include creating a first rasterized semantic map from data acquired from the top-view sensor, receiving a second rasterized semantic map created from data acquired by the perspective-view sensor from the vehicle including the perspective-view sensor, creating a motion flow map learned by matching the first rasterized semantic map and the second rasterized semantic map, and transmitting the learned motion flow map to the vehicle including the perspective-view sensor.

According to another example of the present disclosure, an infrastructure device including a top-view sensor and performing knowledge transfer to a vehicle including a perspective-view sensor may include a memory storing a computer-readable instruction and a processor operated by the instruction. Herein, the instruction may instruct the processor to create a first rasterized semantic map from data acquired from the top-view sensor, to receive, from the vehicle including the perspective-view sensor, a second rasterized semantic map from data acquired by the perspective-view sensor, to create a motion flow map learned by matching the first rasterized semantic map and the second rasterized semantic map, and to transmit the learned motion flow map to the vehicle including the perspective-view sensor.

The features briefly summarized above with respect to the present disclosure are merely exemplary aspects of the detailed description of the present disclosure that follows, and do not limit the scope of the present disclosure.

According to the present disclosure, knowledge transfer can be possible between images acquired from sensors with different views.

Also, or alternatively, according to the present disclosure, object recognition and path prediction suitable for autonomous driving can be possible through the knowledge transfer.

Specifically, according to the present disclosure, knowledge transfer can be possible from a top-view sensor (for example, bird eye view (BEV) sensor) to a perspective-view sensor (for example, onboard sensors).

Also, or alternatively, according to the present disclosure, for example, learning can be performed by reflecting a normal flow and a context according to each object or agent in a current location, which are unpredictable by the onboard sensors in a vehicle capable of autonomous driving. Accordingly, prediction accuracy can be improved in establishing a path plan based on an onboard sensor.

Also, or alternatively, according to the present disclosure, because a rasterized semantic map and a motion flow map are created in an occupancy grid form, like normal image data, variability can be improved through resolution change, cropping, and aspect ratio adjustment, which are easy to use for map matching and domain adaptation.

Also, or alternatively, according to the present disclosure, a normal motion flow of each agent can be represented by learning an agent motion flow through aerial images.

The effects obtainable from the present disclosure are not limited to the above-mentioned effects, and other effects not mentioned herein will be clearly understood by those skilled in the art through the following descriptions.

Although exemplary methods of the present disclosure are represented as a series of operations for clarity of description, the order of the steps is not limited thereto. When necessary, each of the steps may be performed simultaneously or in a different order. In order to realize the method according to the present disclosure, other steps may be added to the illustrative steps, some steps may be excluded from the illustrative steps, or some steps may be excluded while additional steps may be included.

The various examples of the present disclosure are not intended to list all possible combinations but to illustrate representative aspects of the present disclosure. The matters described in the various examples may be applied independently or in a combination of two or more.

Also, the various examples of the present disclosure may be implemented by hardware, firmware, software, or a combination thereof. With hardware implementation, the example may be implemented by using at least one or more of a group of application specific integrated circuits (ASICs), digital signal processors (DSPs), digital signal processing devices (DSPDs), programmable logic devices (PLDs), field programmable gate arrays (FPGAs), general-purpose processors, controllers, micro controllers, and microprocessors.

The scope of the present disclosure includes software or machine-executable instructions (for example, an operating system, an application, firmware, a program, etc.), which cause an operation according to the methods of the various examples to be performed on a device or a computer, and includes a non-transitory computer-readable medium storing such software or instructions to execute on a device or a computer.

What is claimed is:

1. A method comprising:
generating, based on first data acquired by a top-view sensor of an infrastructure device, a first rasterized semantic map;
receiving, from a vehicle comprising a perspective-view sensor, a second rasterized semantic map generated based on second data acquired by the perspective-view sensor;
determining, based on map matching between the first rasterized semantic map and the second rasterized semantic map, a motion flow result; and
sending, to the vehicle, information indicating the motion flow result.

2. The method of claim 1, further comprising performing the map matching based on feature comparison between the first rasterized semantic map and the second rasterized semantic map.

3. The method of claim 2, wherein the map matching comprises comparing at least one of a road edge, a road mark, or a lane, identified in the first rasterized semantic map, to a corresponding feature identified in the second rasterized semantic map.

4. The method of claim 1, wherein the motion flow result comprises a motion flow map that is transformed into a bird eye view (BEV) occupancy grid vector form.

5. The method of claim 1, wherein the motion flow result comprises a motion flow map comprising:
an occupancy probability indicator that indicates a probability based on an occupancy degree of a specific object in the motion flow map, and
a flow indicator that indicates a motion flow of the specific object in the motion flow map.

6. The method of claim 5, wherein the occupancy probability indicator indicates a magnitude of probability of occupancy.

7. The method of claim 1, wherein the first rasterized semantic map and the second rasterized semantic map each comprises one or more layers.

8. The method of claim 1, wherein the first rasterized semantic map and the second rasterized semantic map each comprises:
a layer indicating a lane and at least one vehicle on a road, or
a layer indicating a mark around a crosswalk on the road.

9. A method comprising:
generating, by a processor and based on first data acquired from a perspective-view sensor of a vehicle, a second rasterized semantic map;
sending, to an external infrastructure device comprising a top-view sensor, the second rasterized semantic map;
receiving, from the external infrastructure device and based on the sending, a motion flow map based on map matching of the second rasterized semantic map and a first rasterized semantic map, wherein the first rasterized semantic map is based on data acquired from the top-view sensor;
performing, based on the received motion flow map, path prediction for at least one of the vehicle or a neighbor object of the vehicle; and
causing, based on the path prediction, control of autonomous driving of the vehicle.

10. The method of claim 9, wherein the received motion flow map is in a bird eye view (BEV) occupancy grid vector form, and
wherein the map matching comprises feature comparison between the first rasterized semantic map and the second rasterized semantic map.

11. The method of claim 9, wherein the performing the path prediction comprises:
detecting a type and motion of the neighbor object recognized based on data from the perspective-view sensor of the vehicle;
determining an integrated motion flow for each object in the motion flow map by integrating a detected type and motion of the object and the received motion flow map; and
predicting a path of the neighbor object based on the integrated motion flow.

12. The method of claim 9, wherein the performing of the path prediction comprises:
detecting, based on data from the perspective-view sensor in the vehicle, a motion of the vehicle;
determining an integrated motion flow by integrating the detected motion of the vehicle and the received motion flow map; and
predicting a path of the vehicle based on the integrated motion flow.

13. A vehicle comprising:
a perspective-view sensor;
a memory storing a computer-readable instruction; and
at least one processor, wherein the instruction, when executed by the at least one processor, cause the vehicle to:
generate, based on data from the perspective-view sensor, a second rasterized semantic map;
send, to an external infrastructure comprising a top-view sensor, the second rasterized semantic map;
receive, from external infrastructure device, a motion flow map based on map matching the second rasterized semantic map and a first rasterized semantic map, wherein the first rasterized semantic map is based on data acquired from the top-view sensor;
perform, based on the received motion flow map, path prediction for the vehicle or a neighbor object of the vehicle; and
cause, based on the path prediction, control of autonomous driving of the vehicle.

14. The vehicle of claim 13, wherein the received motion flow map is a bird eye view (BEV) occupancy grid vector form, and
wherein the map matching comprises feature comparison between the first rasterized semantic map and the second rasterized semantic map.

15. The vehicle of claim 13, wherein the instruction, when executed by the at least one processor, causes the processor to perform the path prediction for the neighbor object by:
detecting a type and motion of the neighbor object recognized based on data from the perspective-view sensor of the vehicle,
determining an integrated motion flow for each object in the motion flow map by integrating a detected type and motion of the object and the received motion flow map, and
predicting a path of the neighbor object based on the integrated motion flow.

16. The vehicle of claim 13, wherein the instruction, when executed by the at least one processor, causes the processor to perform the path prediction for the vehicle by:
detecting, based on data from the perspective-view sensor in the vehicle, a motion of the vehicle;
determining an integrated motion flow by integrating the detected motion of the vehicle and the received motion flow map; and
predicting a path of the vehicle based on the integrated motion flow.

17. The vehicle of claim 13, wherein the map matching is performed by feature comparison between the first rasterized semantic map and the second rasterized semantic map.

18. The vehicle of claim 17, wherein the map matching comprises a comparison of at least one of a road edge, a road mark, or a lane, identified in the first rasterized semantic map, to a corresponding feature identified in the second rasterized semantic map.

19. The vehicle of claim 13, wherein the motion flow map is in a bird eye view (BEV) occupancy grid vector form.

20. The vehicle of claim 19, wherein the motion flow map comprises:
an occupancy probability indicator that indicates a probability based on an occupancy degree of a specific object in the motion flow map, and
a flow indicator that indicates a motion flow of the specific object in the motion flow map.
